(19) United States
(12) Patent Application Publication
(10) Pub. No.: US 2003/0231193 A1
(43) Pub. Date: Dec. 18, 2003

(54) Image processing device, image processing method, program and recordintg medium

(76) Inventors: Hiroaki Shimazaki, Katano-shi (JP); Kenjirou Tsuda, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/456,566

(22) Filed: Jun. 9, 2003

(30) Foreign Application Priority Data
Jun. 14, 2002 (JP) 2002-173735

(51) Int. Cl. G09G 5/10

(52) U.S. Cl. 345/690

(57) ABSTRACT

An image processing device is comprised of a decoding unit (501) for (i) decoding input compressed image data into an original image signal and outputting the original image signal, and (ii) reading out, from the compressed image data, compressed image information indicating the type of the original image signal and details of compression; a parameter storing unit (506) for storing a plurality of signal processing parameters and parameter information indicating the characteristics of the respective signal processing parameters; a control unit (504) for determining one of the plurality of signal processing parameters to be used in a signal processing unit (502) on the basis of the compressed image information and the parameter information, and outputting parameter selection information for identifying the determined signal processing parameter; a parameter selecting unit (505) for reading out and outputting such signal processing parameter according to the parameter selection information; and the signal processing unit (502) for performing signal processing on the original image signal inputted by the decoding unit (501) using the signal processing parameter inputted by the parameter selecting unit (505).

### BACKGROUND OF THE INVENTION

(1) Field of the Invention

The present invention relates to an image processing device, an image processing method, a program and a recording medium for correcting the characteristics of a display panel by performing processes on an inputted image signal so as to display the processed image signal as a visually satisfactory image in a portable display apparatus such as a notebook personal computer.

(2) Description of the Related Art

With the improvement in the performance of personal computers (to be referred to as “PC(s)” hereinafter), an increased number of PCs decode compressed image data and display decomposed images in recent years via digital video/versatile discs (to be referred to as “DVD(s)” hereinafter), networks and the like. Such trend applies not only to desktop PCs but also to portable notebook PCs. Furthermore, some personal digital assistants (to be referred to as “PDA(s)” hereinafter) which are smaller in size than notebook PCs also decode compressed image data and display decomposed images in these days.

However, since PCs are not originally intended for displaying image signals, there is a fact that they are inferior to image display apparatuses including television in terms of image quality they can offer. Images that notebook PCs can provide, in particular, are lack of brightness, colorfulness, and vividness due to reasons stemming from power consumption constraints including that the backlight of a liquid crystal panel used as a display device cannot be brightened much and that the color filter cannot be darkened as required because brightness needs to be ensured by saving power consumption.

Under these circumstances, a satisfactory image quality for display is generally obtained using an image processing device that processes an original image signal obtained by decoding compressed image data and outputs such processed signal to a liquid crystal panel. In so doing, existing image processing devices acquire an image signal such as an RGB signal and a YIQ signal, and perform processes such as color correction and gamma correction on the image signal so as to carry out optical correction for a video camera as well as nonlinearity correction for a display device and the like.

As examples of such image processing devices for performing color correction, gamma correction and other processes, there exist an image processing device wherein the image processing device with a processor configuration such as that of DSP (digital signal processor), for example, performs processing on an inputted image signal using software and an image processing support device (e.g. a personal computer) prepares a program executed on the DSP (Refer to Japanese Laid-Open Patent Application No. H10-243259 as an example).

There also exists another image processing device capable of acquiring, from a video decoder for decoding compressed image data, image coding information used at the time of image compression so as to set an image signal processing parameter for adjusting brightness and sharpness according to such image coding information (Refer to Japanese Laid-Open Patent Application No. 2001-326876 as an example).

However, since such image processing devices are configured to perform processing in stationary apparatuses, it is difficult for them to be employed by portable devices, given such issues as power consumption and the scale of a device. Furthermore, since a uniform processing is performed on an image signal without taking into account the characteristics of a display device, there is a problem that image quality of a sufficient level cannot be obtained.

Moreover, when a DSP is used as an image processing device and a program executed on such DSP is prepared in an image processing support system, there arises a problem that a battery life is shortened and that a heavy battery with a large power capacity is required, when considering an object of achieving a colorful display screen by aggressively performing color enhancement for display devices with poor color reproducibility such as liquid crystal panels employed by portable display devices including notebook personal computers and PDAs, since the DSP has drawbacks in terms of power consumption.

Furthermore, when acquiring image coding information used at the time of image compression from a video decoder that decodes compressed image data and sets an image signal processing parameter for adjusting brightness and sharpness simply according to such image coding information, it is possible to determine a suitable fixed value used as a reference of correction depending on a display device, if only a specified type of display devices are employed. However, when a single image processing device needs to support multiple types of display devices, there is a possibility that image quality of a sufficient level cannot be achieved since a value suitable for the actual characteristics of a display device is not necessarily obtained.

Furthermore, when an input image signal is an image resulted from decoding compressed image data such as that of MPEG 2, an image processing device that enhances the brightness and colors of the image signal by processing an image signal before outputting it onto a display device, also enhances compressed noise together with brightness and colors, due to which a satisfactory image cannot be obtained in some cases.

The present invention has been conceived in view of the aforementioned problems, and it is an object of this invention to provide an image processing device, an image processing method, a program and a recording medium that are suited to be incorporated into a portable display device in terms of power consumption and the scale of a device, that display an original image signal obtained by decoding compressed image data without enhancing its compressed noise, and that allow, even when more than one type of display devices are used, each of such display devices to be performed of optimal brightness/color correction and enhancement as well as allowing volume production of display apparatuses which incorporate such a display device and an image processing device as a set.

### SUMMARY OF THE INVENTION

In order to achieve the above object, the image processing device according to the present invention is an image processing device for performing signal processing on an input image signal according to a signal processing parameter that associates the image signal with a display style of the image signal, the image processing device comprising: a decoding unit operable to (i) decode input compressed image data into an original image signal and output the original image signal, and (ii) read out, from the compressed image data, compressed image information indicating a type of the original image signal and details of compression and output the readout compressed image information; a parameter storing unit operable to store a plurality of signal processing parameters; a control unit operable to determine one of the plurality of signal processing parameters on the basis of the compressed image information outputted by the decoding unit and the plurality of signal processing parameters read out from the parameter storing unit, and output parameter selection information for identifying the determined signal processing parameter; a parameter selecting unit operable to read out and output said one of the plurality of signal processing parameters stored in the parameter storing unit according to the parameter selection information outputted by the control unit; and a signal processing unit operable to perform signal processing on the original image signal outputted by the decoding unit according to the signal processing parameter outputted by the parameter selecting unit.

Moreover, the image processing device according to the present invention is an image processing device for performing signal processing on an input image signal according to a signal processing parameter that associates the image signal with a display style of the image signal, the image processing device comprising: a decoding unit operable to (i) decode input compressed image data into an original image signal and output the original image signal, and (ii) read out, from the compressed image data, compressed image information indicating a type of the original image signal and details of compression and output the readout compressed image information; a parameter storing unit operable to store a plurality of signal processing parameters and parameter information of each of the plurality of signal processing parameters indicating a characteristic of how the image signal and the display style are associated with each other; a control unit operable to determine one of the plurality of signal processing parameters on the basis of the compressed image information outputted by the decoding unit and the parameter information outputted by the parameter storing unit, and output parameter selection information for identifying the determined signal processing parameter; a parameter selecting unit operable to read out and output said one of the plurality of signal processing parameters stored in the parameter storing unit according to the parameter selection information outputted by the control unit; and a signal processing unit operable to perform signal processing on the original image signal outputted by the decoding unit according to the signal processing parameter outputted by the parameter selecting unit.

Accordingly, since a signal processing parameter is selected according to compressed image data, it is possible to perform such optimum signal processing as prevents noise from becoming noticeable by suppressing brightness and colors, when the image data has been compressed at a high compression ratio, and by sufficiently enhancing brightness and colors, when the image data has been compressed at a low compression ratio, for example.

Furthermore, in the above image processing device, it is desirable that the control unit determines one of the plurality of signal processing parameters reflecting a characteristic of a display device that is post-connected to the image processing device, and outputs the parameter selection information for identifying the determined signal processing parameter reflecting the characteristic of the display device.

Accordingly, since a signal processing parameter to be used is selected depending on compressed image data from among a plurality of signal processing parameters reflecting the characteristics of a display device, it is possible to perform brightness/color correction and enhancement best suited for the display device, as well as performing such signal processing as prevents noise from becoming noticeable by suppressing brightness and colors, when the image data has been compressed at a high compression ratio, and by sufficiently enhancing brightness and colors, when the image data has been compressed at a low compression ratio, for example.

Also, in the above image processing device, the signal processing unit may perform at least one of lowpass filter processing, color expansion processing and partial brightness enhancement processing, and the control unit may determine, from among the plurality of signal processing parameters, a signal processing parameter that also makes a pass band narrower in lowpass filter processing, when an increased amount of color expansion is performed.

Accordingly, it is possible to always display images with satisfactory image quality by making a pass band narrower only when compression noise is likely to be enhanced in subsequent signal processing.

Moreover, the above image processing device may further comprise a brightness control signal generating unit operable to output a brightness control signal for controlling brightness of a light source of a display device which is post-connected to the image processing device, according to the parameter selection information outputted by the control unit.

Accordingly, since an adjustment is made to brightness also by controlling the light source of the display device 3, it is possible to prevent noise from becoming too noticeable due to an increased amount of brightness enhancement indicated by a signal processing parameter.

Note that not only is it possible to embody the present invention as an image processing device with the above configuration but also as an image processing method that includes as its steps characteristic units of the device according to the present invention, and as a program which has a computer execute such steps. It should be also understood that such program can be distributed via recording medium including CD-ROM and the like as well as via transmission medium including the internet and the like.

For further information about the technical background of this invention, Japanese patent application No. 2002-173735 filed Jun. 14, 2002, is incorporated herein by reference.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a block diagram showing a configuration of an image processing device according to the first embodiment of the present invention.

FIG. 2 is a block diagram showing a configuration of an image processing support system for setting signal processing parameters to be stored in a parameter storing unit.

FIG. 3 is a diagram showing an example result of measuring the gamma characteristic of a display device.

FIG. 4 is a diagram showing an example result of measuring the color reproducibility of the display device.

FIG. 5 is a block diagram showing a configuration of an image processing circuit.

FIG. 6 is a block diagram showing a configuration of an inverse gamma correction circuit.

FIG. 7 is a diagram explaining the contents of correction processing in the inverse gamma correction circuit.

FIG. 8 is a block diagram showing a configuration of a color conversion processing circuit.

FIG. 9 is a diagram showing an example processing characteristic specified by an inverse gamma correction parameter.

FIG. 10 is a diagram showing an example processing characteristic specified by a color conversion parameter.

FIG. 11 is a diagram showing an example processing characteristic specified by a gamma correction parameter.

FIG. 12 is a block diagram showing a configuration of an image processing device which is embodied by employing software processing and the image processing circuit.

FIG. 13 is a block diagram showing a configuration of an image processing circuit according to the second embodiment of the present invention.

FIG. 14 is a block diagram showing a configuration of an image processing device according to the third embodiment of the present invention.

### DESCRIPTION OF THE PREFERRED EMBODIMENTS

The following explains the preferred embodiments of the present invention with reference to the figures.

(First Embodiment)

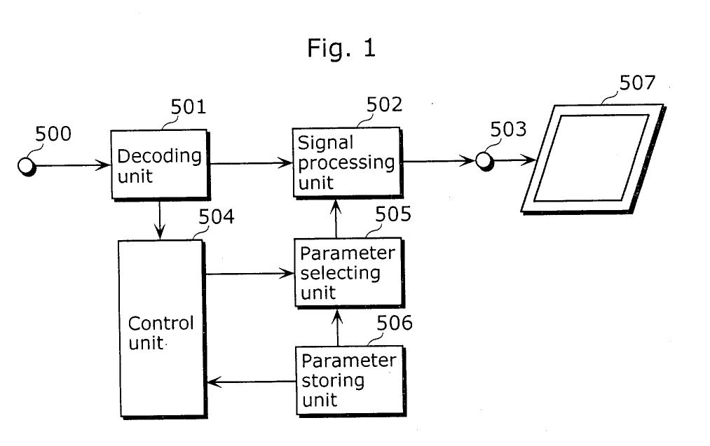

FIG. 1 is a block diagram showing the configuration of an image processing device according to the first embodiment of the present invention.

As shown in FIG. 1, this image processing device includes an input terminal 500, a decoding unit 501, a signal processing unit 502, an output terminal 503, a control unit 504, a parameter selecting unit 505, and a parameter storing unit 506. The output terminal 503 is connected to a display device 507.

The decoding unit 501 decodes compressed image data inputted from the input terminal 500 into a decomposed original image signal so as to output it to the signal processing unit 502. Furthermore, the decoding unit 501 reads out compressed image information indicating the type of the original image signal and details of compression from such compressed image data, and outputs it to the control unit 504.

A plurality of signal processing parameters for visually improving the image quality of a display image in accordance with the characteristics of the display device 507 and a plurality of parameter information indicating the characteristics of the respective signal processing parameters, are stored in the parameter storing unit 506 in advance. A signal processing parameter, which associates an image signal with its display style, is made up of an inverse gamma correction parameter, a color conversion parameter, a gamma correction parameter and the like, and more than one set of signal processing parameters are stored in the parameter storing unit 506. Meanwhile, parameter information indicates the characteristics of how an image signal and its display style are associated with each other on the basis of each signal processing parameter. The amount of color expansion indicated by a color conversion parameter and the amount of partial brightness enhancement (e.g. an output value with respect to a predetermined input value) indicated by a gamma correction parameter, for example, can be used as parameter information.

The control unit 504 determines a signal processing parameter to be used in the signal processing unit 502 from among a plurality of the signal processing parameters stored in the parameter storing unit 506, according to both the compressed image information inputted from the decoding unit 501 and parameter information inputted from the parameter storing unit 506. Then, the control unit 504 outputs, to the parameter selecting unit 505, parameter selection information used for reading out such determined signal processing parameter.

The parameter selecting unit 505 reads out, from the parameter storing unit 506, the signal processing parameter determined by the control unit 504 on the basis of the parameter selection information inputted from the control unit 504, and outputs it to the signal processing unit 502. Note that any information may serve as parameter selection information as long as an address in the parameter storing unit 506, a number and the like arbitrarily assigned to each of the signal processing parameters, and a signal processing parameter stored in the parameter storing unit 506 can be identified by such information.

The signal processing unit 502 performs signal processing on the original image signal inputted from the decoding unit 501, using the signal processing parameter inputted from the parameter selecting unit 505.

Next, an explanation is given for the operation of the image processing device with the above configuration.

The parameter storing unit 506 outputs parameter information it stores, when the image processing device starts operating (e.g. when the power is turned on) in response to an instruction of the control unit 504.

Compressed image data inputted from the input terminal 500 is then inputted to the decoding unit 501. The decoding unit 501 decodes the input compressed image data into a decomposed original image signal, and outputs it to the signal processing unit 502. At the same time, the decoding unit 501 reads out compressed image information indicating the type of the original image signal and details of compression processing from such compressed image data, and outputs it to the control unit 504.

The control unit 504 determines a signal processing parameter to be used in the signal processing unit 502 from among a plurality of the signal processing parameters stored in the parameter storing unit 506, according to both the compressed image information inputted from the decoding unit 501 and parameter information inputted from the parameter storing unit 506. Then, the control unit 504 outputs, to the parameter selecting unit 505, parameter selection information used for reading out such determined signal processing parameter. The parameter selecting unit 505 reads out, from the parameter storing unit 506, the signal processing parameter determined by the control unit 504 on the basis of the parameter selection information inputted from the control unit 504, and outputs it to the signal processing unit 502.

The signal processing unit 502 performs signal processing on the original image signal inputted from the decoding unit 501, using the signal processing parameter inputted from the parameter selecting unit 505, and outputs the processed original image signal onto the display device 507 via the output terminal 503.

Through the above operation, it is possible for the image processing device illustrated in FIG. 1 to perform image processing on an original image signal resulted from decoding the compressed image data, the image processing best suited for a combination of the characteristics of compressed image data inputted from the input terminal 500 and the cahracterstics of the display device 507, and therefore to offer high-quality image display. Note that constitute elements illustrated in the block diagram of FIG. 1 may be realized either as hardware or software here, but assuming that the image processing device according to the present invention is incorporated into a currently available note book PC, the following provides explanations provided that the decoding unit 501 and the control unit 504 are realized as software, and the signal processing unit 502, the parameter selecting unit 505 and the parameter storing unit 506 as hardware.

Next, an explanation is given for a method for setting a plurality of. signal processing parameters appropriate to the characteristics of the display device 507 and a plurality of parameter information indicating the characteristics of each of the signal processing parameters stored in advance in the parameter storing unit 506 of the image processing device illustrated in FIG. 1.

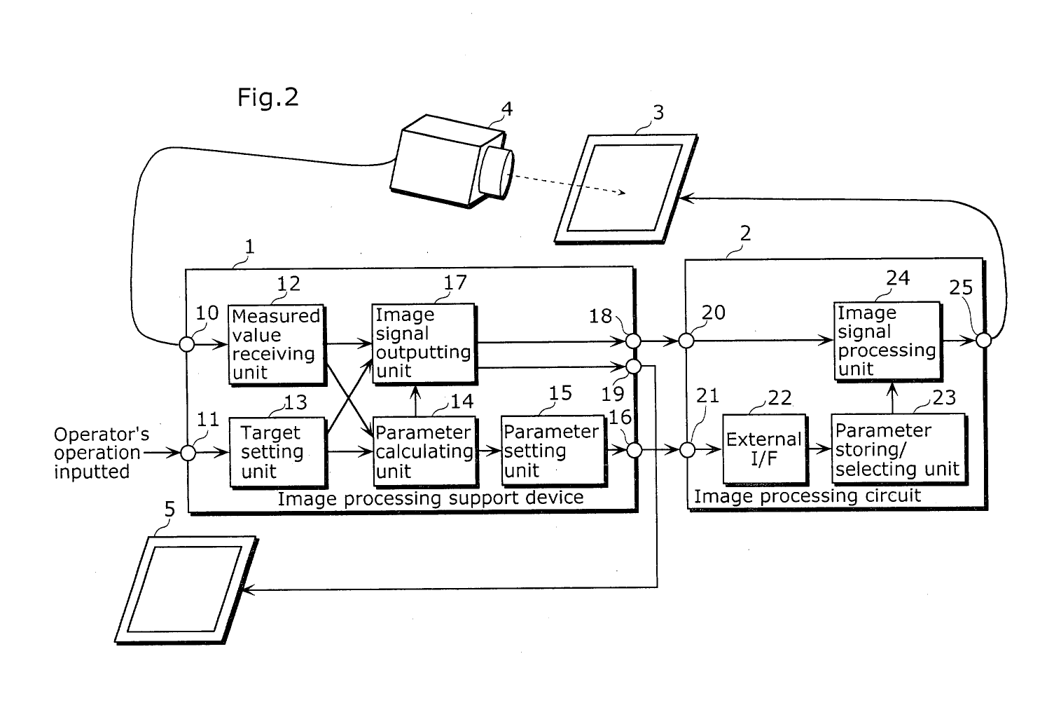

FIG. 2 is a block diagram showing the configuration of an image processing support system for setting the parameters to be stored in the parameter storing unit 506.

Such image processing support system, which is a system for making adjustments to signal processing parameters used by an image processing circuit 2 to suit a display device 3, is comprised of an image processing support device 1, the image processing circuit 2, a display device 3, a measuring device 4, and an operation screen display device 5, as illustrated in FIG. 2.

The image processing support device 1 is comprised of input terminals 10 and 11, a measured value receiving unit 12, a target setting unit 13, a parameter calculating unit 14, a parameter setting unit 15, an output terminal 16, an image signal outputting unit 17, and output terminals 18 and 19.

The image signal outputting unit 17 outputs measurement image signals for measuring the gamma characteristic and color reproducibility of the display device 3. The measured value receiving unit 12 receives measurement results from the measuring device 4 via the input terminal 10, and stores the received results. The target setting unit 13 notifies the parameter calculating unit 14 and the image signal outputting unit 17 of target values which an operator has inputted via the input terminal 11. The parameter calculating unit 14 calculates parameters on the basis of the measurement results notified by the measured value receiving unit 12 and the target values notified by the target setting unit 13. The parameter setting unit 15 outputs such parameters to the image processing circuit 2 via the output terminal 16.

The image processing circuit 2 is comprised of an input terminal 20, an input/output terminal 21, an external interface 22, a parameter storing/selecting unit 23, an image signal processing unit 24, and an output terminal 25.

Here, the image signal processing unit 24 corresponds to the signal processing unit 502 in FIG. 1, the parameter storing/selecting unit 23 to the parameter selecting unit 505 and to the parameter storing unit 506 in FIG. 1, and the display device 3 to the display device 507 in FIG. 1.

The following explanation is provided on the assumption that the image processing circuit 2 is embodied as a combination of the external interface 22 with the image signal processing unit 24 (the signal processing unit 502) and the parameter storing/selecting unit 23 (the parameter selecting unit 505 and the parameter storing unit 506). To be more specific, the image processing circuit 2 is realized as an LSI which will be mounted on a notebook PC. An explanation of the other constituent elements illustrated in FIG. 1, i.e., the decoding unit 501 and the control unit 504 to be embodied as software, is given later in the present embodiment with reference to a diagram.

First, an explanation is given for the operation for measuring the gamma characteristic and color reproducibility of the display device 3 in the image processing support system with the above configuration.

The image signal outputting unit 17 of the image processing support device 1 outputs measurement image signals for measuring the gamma characteristic and color reproducibility of the display device 3. Such measurement image signals are outputted to the display device 3 via the image processing circuit 2, but it is necessary that processes including gamma correction and color enhancement shall not be performed by the image processing circuit 2 while measurement is ongoing. For this reason, the parameter calculating unit 14 of the image processing support device 1 prepares such measurement parameters as make the image signal processing unit 24 not perform signal processes such as gamma correction and color enhancement on the input signals from the input terminal 20 so that such input signals can be delivered to the output terminal 25 as source signals. The parameter setting unit 15 outputs the measurement parameters prepared by the parameter calculating unit 14 to the image processing circuit 2 via the output terminal 16. Such measurement parameters are inputted to and stored in the parameter storing/selecting unit 23 via the input/output terminal 21 and the external interface 22. The parameter storing/selecting unit 23 provides such stored measurement parameters to the image signal processing unit 24.

The measuring device 4 measures the brightness and color of the measurement image signals displayed on the display device 3, and outputs the measurement results to the image processing support device 1. The measured value receiving unit 12 receives and stores the measurement results inputted to the input terminal 10 of the image processing support device 1.

As measurement image signals outputted by the image signal outputting unit 17, a plurality of image signals such as ones for monochrome display (e.g. whole red, green or blue) and ones for monochrome display of a plurality of gray levels are switched and used. In order to synchronize the switching of measurement image signals with the measuring operation of the measuring device 4, the measured value receiving unit 12, on the receipt of the measurement results from the measuring device 4, outputs to the image signal outputting unit 17 a reception notification signal indicating that it received the measurement results. The image signal outputting unit 17 makes a switch of measurement image signals after receiving such reception notification signal.

By repeating the aforementioned operation, characteristic data such as the gamma characteristic, color reproducibility and the like of the display device 3 is stored in the measured value receiving unit 12.

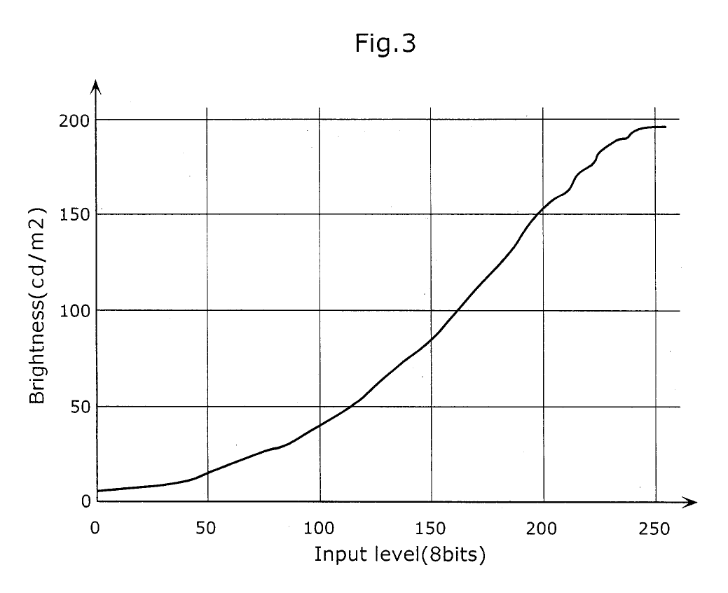

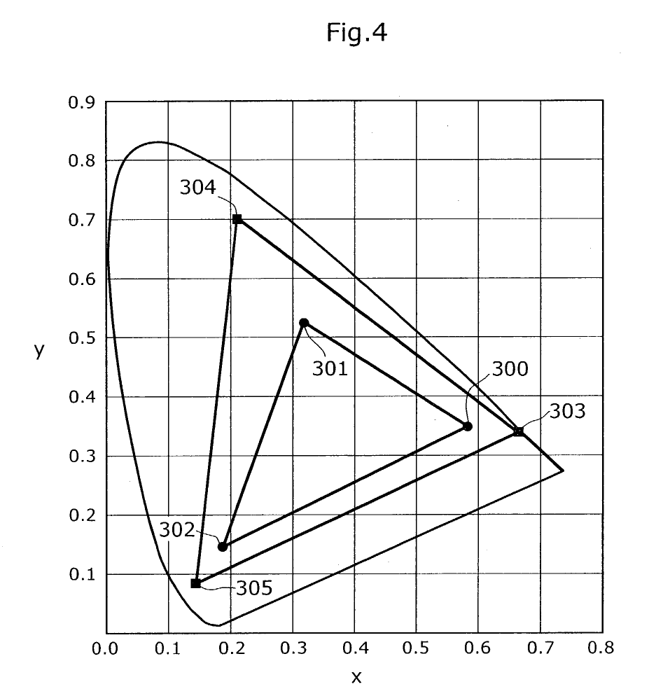

FIG. 3 is a diagram showing an example result of measuring the gamma characteristic of the display device 3, while FIG. 4 is an example result of measuring the color reproducibility of the display device 3. In the present embodiment, the display device 3 receives and displays 8-bit parallel RGB digital signals.

The gamma characteristic of the display device 3 as illustrated in FIG. 3 can be obtained by changing values between achromatic, i.e. monochrome signals (which display on the entire screen a single value as three signals of RGB) of black (R=0, G=0, B=0) and white (R=255, G=255, B=255) as measurement image signals so as to display and make a measurement. The gamma characteristic of a general display device shows a nonlinear characteristic as illustrated in FIG. 3.

Meanwhile, chromaticity indicated by a point R300 shown in FIG. 4 can be obtained by displaying and measuring a signal showing red on the entire screen (R=255, G=0, B=0) as a measurement image signal. Similarly, chromaticity indicated by a point G301 in FIG. 4 is obtained by a signal showing green on the entire screen (R=0, G=255, B=0), and chromaticity indicated by a point B302 in FIG. 4 is obtained by a signal showing blue on the entire screen (R=0, G=0, B=255). Assuming that the display device 3 is a liquid crystal panel and the like used for such a portable display apparatus as a notebook PC, a triangle-shaped area, i.e. color reproducibility, formed by connecting RGB points, is generally smaller than the reproducibility represented by a triangle formed by connecting the point R303, the point G304, and the point B305 in the scope of the NTSC standard. For this reason, when displaying an image signal in conformity with the NTSC standard, for example, a light-colored image is displayed.

Next, a detailed explanation is given for the processing to be performed by the image processing circuit 2.

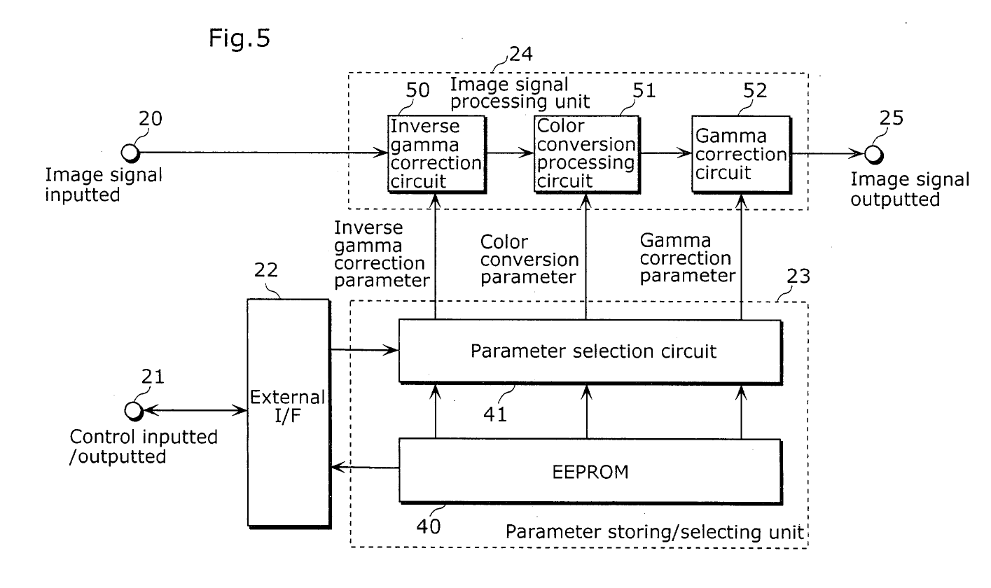

FIG. 5 is a block diagram showing the internal configuration of the image processing circuit 2 according to the preferred embodiment of the present invention. Note that the same numbers are assigned to the same components as those illustrated in FIG. 2.

The parameter storing/selecting unit 23 of the image processing circuit 2 includes an EEPROM 40, and a parameter selection circuit 41. The image signal processing unit 24 includes an inverse gamma correction circuit 50, a color conversion processing circuit 51, and a gamma correction circuit 52.

An explanation is given here by defining the following three parameters as one set of signal processing parameter handled by the image processing support device 1 and the image processing circuit 2: inverse gamma correction parameter, color conversion parameter, and gamma correction parameter. The EEPROM 40 stores more than one set of signal processing parameters, each made up of the above three types of signal processing parameters, as well as a plurality of parameter information corresponding to each of such plurality of signal processing parameters. Assume that the EEPROM 40 stores, as parameter information, the amount of color expansion indicated by a color conversion parameter and the amount of partial brightness enhancement indicated by a gamma correction parameter.

Signal processing parameters and parameter information inputted from the image processing support device 1 are written to the EEPROM 40 via the external interface 22. The use of EEPROM (Electrically-Erasable and Programmable ROM) for storing signal processing parameters and parameter information in the image processing circuit 2 makes it possible for the image processing circuit 2 to perform image processing in accordance with the once-stored signal processing parameters, without requiring the input of such signal processing parameters from the image processing support device 1.

The parameter information written to the EEPROM 40 is outputted to the input/output terminal 21 via the external interface 22. The parameter selection circuit 41 reads out one signal processing parameter identified by parameter selection information from among a plurality of the signal processing parameters stored in the EEPROM 40. Reading of a signal processing parameter can be easily carried out by storing signal processing parameters to different addresses in the EEPROM 40 and appropriately selecting an address in the EEPROM 40 from which a signal processing parameter is read out.

An inverse gamma correction parameter which has been read out by the parameter selection circuit 41 is outputted to the inverse gamma correction circuit 50. Then, on the basis of such inputted inverse gamma correction parameter, the inverse gamma correction circuit 50 performs an inverse gamma correction process on an image signal inputted from the input terminal 20, and outputs the processed image signal to the color conversion processing circuit 51. A color conversion parameter read out by the parameter selection circuit 41 is outputted to the color conversion processing circuit 51, which then performs a color conversion process on the image signal inputted from the inverse gamma correction circuit 50, on the basis of the inputted color conversion parameter, and outputs the processed image signal to the gamma correction circuit 52. A gamma correction parameter read out by the parameter selection circuit 41 is outputted to the gamma correction circuit 52, which then performs a gamma correction process on the image signal inputted from the color conversion processing circuit 51, on the basis of the inputted gamma correction parameter, and outputs the processed image signal to the output terminal 25.

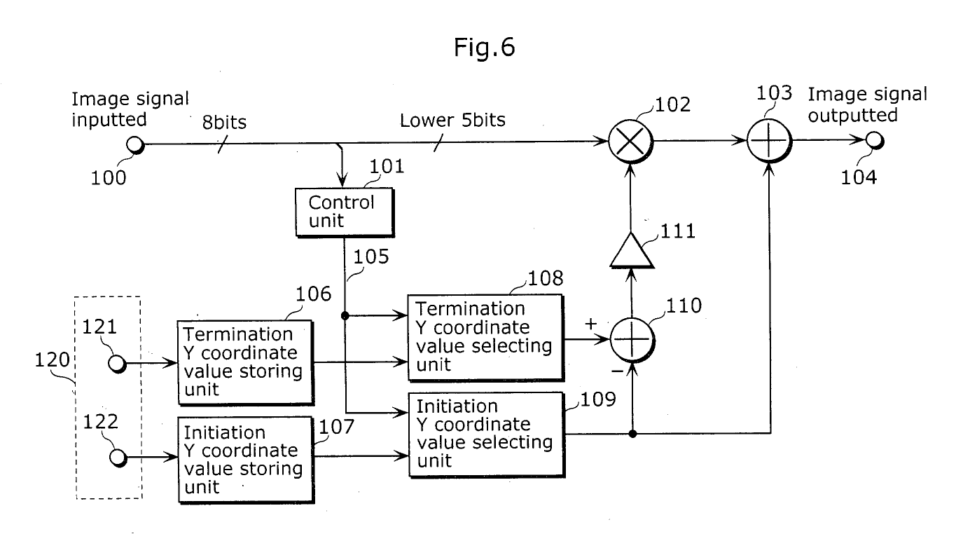

FIG. 6 is a block diagram showing the configuration of the inverse gamma correction circuit 50.

The inverse gamma correction circuit 50 has an input terminal 100, a control unit 101, a multiplier 102, an adder 103, an output terminal 104, a termination Y coordinate value storing unit 106, an initiation Y coordinate value storing unit 107, a termination Y coordinate value selecting unit 108, an initiation Y coordinate value selecting unit 109, a subtracter 110, a divider 111, a parameter input terminal 120, and input terminals 121 and 122. Note that FIG. 6 is a block diagram showing a circuit in the inverse gamma correction circuit 50 that processes only one signal out of RGB signals, and therefore that the inverse gamma correction circuit 50 has three circuits for all RGB signals in parallel which are equivalent to the circuit shown in FIG. 6.

In this inverse gamma correction circuit 50, the characteristic of inverse gamma correction is more closely analogous to a broken line divided into eight parts. In other words, an inputted image signal is judged which part to belong to of the eight parts according to the level of such image signal, and processed to be converted into an output value through linear approximate calculation in a part determined in accordance with the result of such judgment.

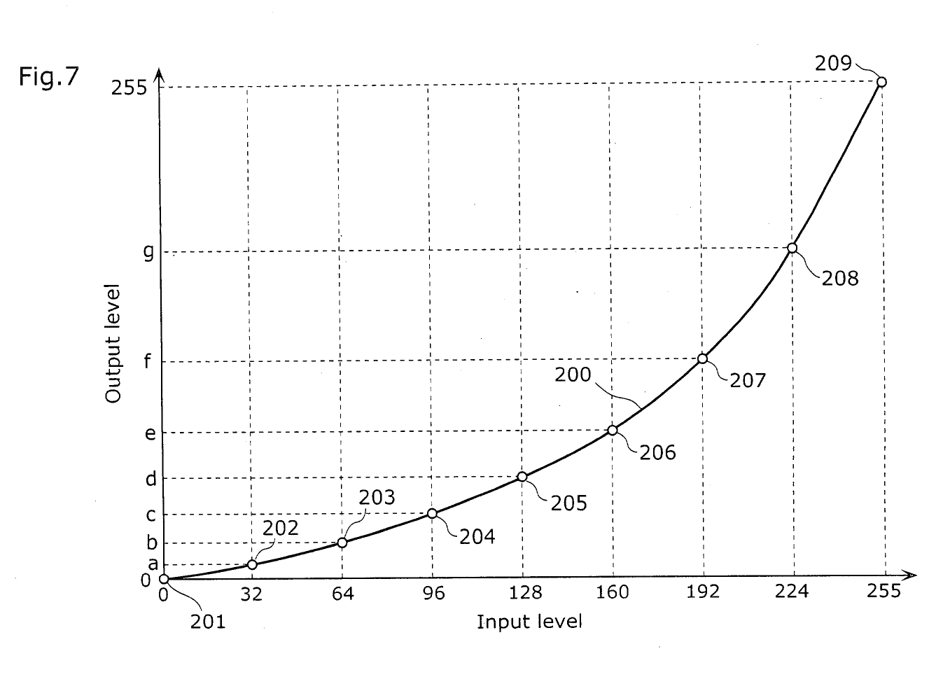

FIG. 7 is a diagram explaining the contents of the correction process performed by the inverse gamma correction circuit 50 illustrated in the block diagram of FIG. 6. The horizontal axis indicates the level of an image signal inputted from the input terminal 100, while the vertical axis indicates the level of the image signal outputted from the output terminal 104. Depending on which of the eight parts resulted from dividing the input level for every 32 values (indicated by eight lines: 201-202, 202-203, 203-204, 204-205, 205-206, 206-207, 207-208, and 208-209) such inputted image signal belongs to, an approximation process is performed for the corresponding part. Y axis values corresponding to the both edges of each of the eight parts (i.e. 0, a, b, c, d, e, f, g, and 255) are an inverse gamma correction parameter in the present embodiment.

Initiation Y coordinate values of the eight lines, i.e. output level values (0, a, b, c, d, e, f, and g) indicated by break points on the left of each line in FIG. 7 are stored as initiation Y coordinate values by the initiation Y coordinate value storing unit 107 via the input terminal 122. Furthermore, termination Y coordinate values of the eight lines, i.e.; output level values (a, b, c, d, e, f, g, and 255) indicated by break points on the right of each line in FIG. 7 are stored as termination Y coordinate values by the termination Y coordinate value storing unit 106 via the input terminal 121.

The 8-bit parallel image signal inputted from the input terminal 100 is divided into the upper 3 bits and the lower 5 bits, and the upper 3 bits are inputted to the control unit 101 and the lower 5 bits are inputted to the multiplier 102 respectively. Using such 3 bit values, the control unit 101 judges which part on the broken line in FIG. 7 the inputted image signal belongs to, and. controls the termination Y coordinate value selecting unit 108 and the initiation Y coordinate value selecting unit 109 by the use of a judgment result signal 105 in accordance with the result of such judgment. Under the control of the control unit 101, the termination Y coordinate value selecting unit 108 and the initiation Y coordinate value selecting unit 109 respectively output Y coordinate values indicating the both ends of the part which the input image signal belong to, out of the Y coordinate values corresponding to the broken lines stored in the termination Y coordinate value storing unit 106 and the initiation Y coordinate value storing unit 107.

A value indicating the slope of the broken line corresponding to the part which the input image signal belongs to is determined by subtracting by the subtracter 110 the value outputted from the initiation Y coordinate value selecting unit 109 from the value outputted from the termination Y coordinate value selecting unit 108, and further by dividing the resulting value by the fixed value 32 by the divider 111. Such resulting slope value outputted from the divider 111 is outputted to the multiplier 102. The multiplier 102 outputs to the adder 103 a value to be determined by multiplying the slope value from the divider 111 by the lower 5 bits of the input image signal from the input terminal 100, i.e. an offset value on the Y axis derived from the initiation Y coordinate value on the broken line corresponding to the input image signal. The adder 103 adds the inputted offset value with the initiation Y coordinate value on the broken line corresponding to the input image signal inputted from the initiation Y coordinate value selecting unit 109 so as to determine a value of the output level, and outputs the result to the output terminal 104.

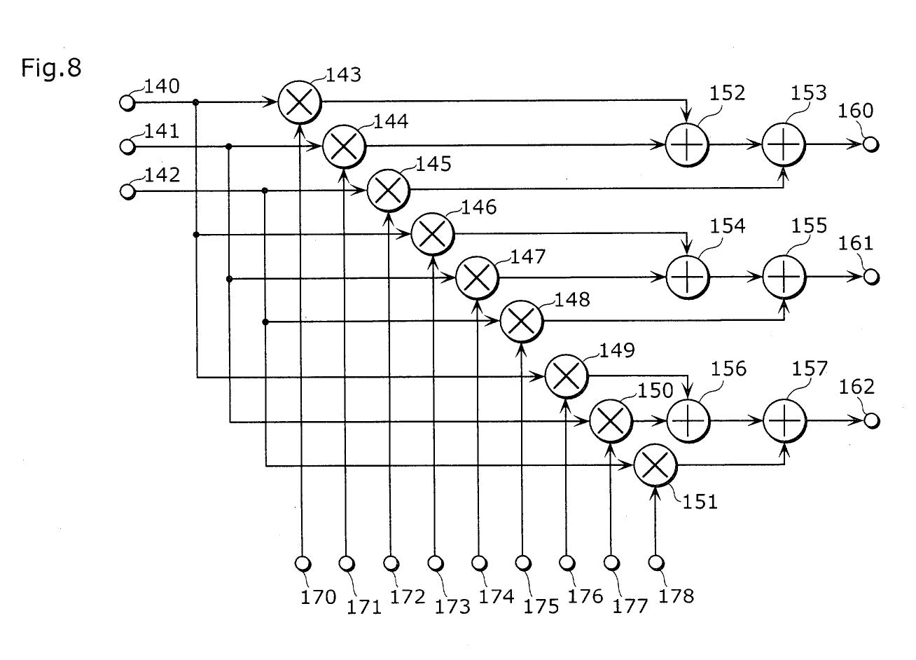

FIG. 8 is a block diagram showing the configuration of the color conversion processing circuit 51.

The color conversion processing circuit 51 has input terminals 140, 141, and 142, multipliers 143, 144, 145, 146, 147, 148, 149, 150 and 151, adders 152, 153, 154, 155, 156 and 157, output terminals 160, 161, and 162, and input terminals 170, 171, 172, 173, 174, 175, 176, 177, and 178. Note that FIG. 8 is a diagram depicting all signals of RGB.

The color conversion processing circuit 51 performs a color conversion process on inputted RGB image signals through 3×3 matrix calculation. Assuming that the input RGB signals are respectively R, G, and B, output signals are respectively R′, G′, and B′, and a color conversion parameter consists of A11, A12, A13, A21, A22, A23, A31, A32, and A33, a calculation to be performed in the color conversion processing circuit 51 illustrated in FIG. 8 is represented by the following Expression (1):

$$( \begin{matrix}{R}^{′} \\ {G}^{′} \\ {B}^{′}\end{matrix} ) = ( \begin{matrix}A11 & A12 & A13 \\ A21 & A22 & A23 \\ A31 & A32 & A33\end{matrix} ) ( \begin{matrix}R \\ G \\ B\end{matrix} ) \qquad ( 1 )$$

Therefore, when the R signal is inputted to the input terminal 140, the G signal to the input terminal 141, and the B signal to the input terminal 142 respectively, the parameter A11 is inputted to the input terminal 170, the parameter A12 to the input terminal 171, the parameter A13 to the input terminal 172, the parameter A21 to the input terminal 173, the parameter A22 to the input terminal 174, the parameter A23 to the input terminal 175, the parameter A31 to the input terminal 176, the parameter A32 to the input terminal 177, and the parameter A33 to the input terminal 178 respectively. As a result of performing calculations for these parameters, the R′ signal is outputted to the output terminal 160, the G′ signal to the output terminal 161, and the B′ signal to the output terminal 162 respectively.

In the present embodiment, what the color conversion processing circuit 51 performs is not only a simple color correction process but also such processes as color enhancement or color control, as well as hue change. For this reason, a signed color conversion parameter is inputted to the input terminals 170˜178 in the color conversion processing circuit 51. Furthermore, each of the RGB image signals to be appearing in the output terminals 160, 161 and 162 is configured not to be limited by a limiter to be in the range of 8-bit parallel signals, but configured to be outputted as image signals which are signed and which are extended in their signal ranges. In the following explanation, the color conversion processing circuit 51 has a configuration in which signed 10-bit parallel RGB signals are outputted from the output terminals 160, 161 and 162.

Moreover, the gamma correction circuit 52 can be embodied by employing a circuit with the configuration equivalent to that of the inverse gamma correction circuit 50 illustrated in FIG. 6. Note, however, that since the input image signal has been performed of the additional process in the color conversion processing circuit 51, some small changes may be required in the configuration as well as in the contents of parameter calculation. Descriptions in this respect are provided later.

Next, an explanation is given for the operation for calculating signal processing parameters in the image processing support device 1 illustrated in FIG. 1.

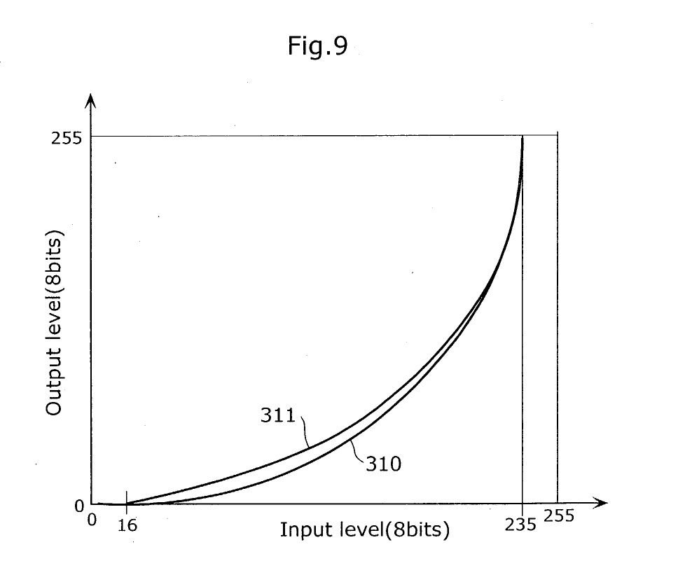

FIG. 9 is a diagram showing an example processing characteristic specified by the inverse gamma correction parameter. Assuming that an image signal to be inputted is such an image signal as an NTSC-compliant image signal for which receiver's gamma correction is performed in advance on the part of a video camera, it is necessary for the inverse gamma correction circuit 50 to calculate the inverse characteristic of such receiver's gamma correction characteristic in order to obtain a linear signal. Accordingly, the parameter calculating unit 14 calculates an inverse gamma correction parameter which has the inverse gamma characteristic represented by a curve 310 illustrated in FIG. 9.

Regarding the calculation performed by the parameter calculating unit 14, since the characteristics of the display device do not have a direct influence on the inverse gamma correction characteristic, all that is required is to calculate the inverse characteristic of the NTSC-compliant receiver's gamma correction characteristic as an inverse gamma correction parameter, and the result of such calculation is just required to be stored as a fixed value. For example, letting an input signal and an output signal of the inverse gamma correction circuit 50 be Xg and Yg respectively, the curve 310 in FIG. 9 can be determined using the following Expression (2):

When Xg<16,

Yg=0

When 16≦Xg≦235,

Yg=255×((Xg−16)/(235−16))**(1/2.2)

When 235<Xg,

Yg=255 (2)

Note that “**” indicates an exponential calculation in this specification.

In other words, the parameter calculating unit 14 determines, by the use of the above Expression (2), an inverse gamma correction parameter which indicates Y axis values corresponding to the both ends of the eight parts resulted from dividing the input level for every 32 levels as explained above.

Such parameter calculating unit 14 can be easily embodied by employing a microcomputer as hardware, for example, and implementing Expression (2) on software to be executed on such microcomputer. Or, since the value of Xg is fixed in the inverse gamma correction circuit 50 illustrated in FIG. 6, it is also possible that the parameter calculating unit 14 stores a value for Yg that corresponds to the value of Xg to be determined using Expression (2).

Moreover, in order to improve visibility in such content as a movie that includes many dark scenes, it is possible to set a part indicating a low input level slightly higher as represented by the curve 311 in FIG. 9. Such curve 311 can be calculated by adding a certain brightness enhancement coefficient to a low input level part when calculating parameters. For example, Expression (2) can be changed as follows (“**” indicates an exponential operation):

When Xg<16,

Yg=0

When 16≦Xg<2×B,

Yg=255×((Xg−16)/(235−16)**(1/2.2))+A×(1−cos(π((Xg−16)/B)))

When 2×B≦Xg≦235,

Yg=255×((Xg−16)/(235−16)**(1/2.2))

When 235<Xg,

Yg=255 (3)

Using Expression (3), the parameter calculating unit 14 can calculate an inverse gamma correction parameter resulted from enhancing only the maximum level A of the original inverse gamma correction characteristic, with (Xg−16)=B as the peak. When this is done, by substituting a negative value into A, it is also possible to determine such an inverse gamma correction parameter as enables the level of a low input level part to be lowered and therefore compression noise to be made less noticeable. Furthermore, the parameter calculating unit 14 is also capable of displaying a graph generated by the use of Expression (3) on the operation image display device 5 via the image signal outputting unit 17 so as to make an adjustment to values corresponding to A and B in Expression (3) in accordance with an operator's input.

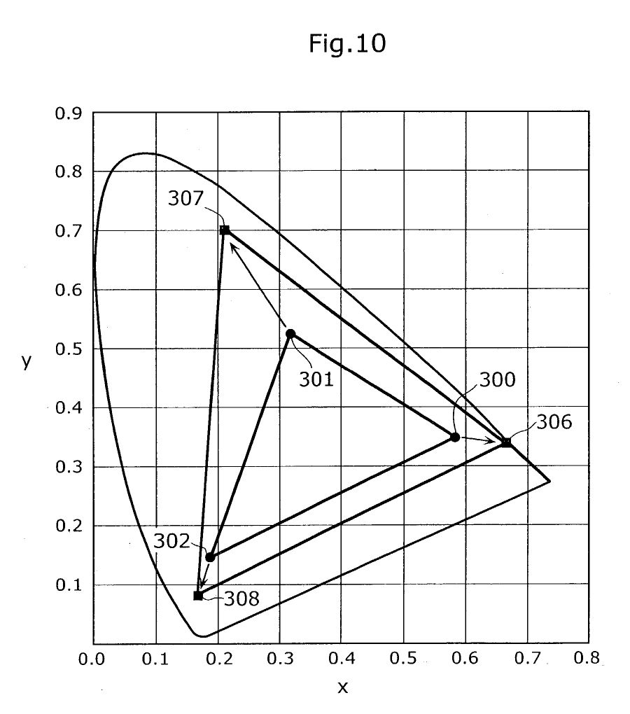

FIG. 10 is a diagram showing an example processing characteristic specified by the color conversion parameter.

The point R300, the point G301, and the point B302 on the xy chromaticity diagram form a triangle indicating the color reproducibility of the display device 3 measured by following the aforementioned procedure. Meanwhile, a point R306, a point G307, and a point B308 are chromaticity points indicating the target color reproducibility to be obtained. Note that the chromaticity points R306, G307, and B308 indicating the color reproducibility to be obtained are not necessarily identical with the chromaticity points R303, G304 and B305 indicating the color reproducibility of the NTSC standard illustrated in FIG. 4.

The color conversion processing circuit 51 performs processing for increasing the amplitude of the color signals so as to approximate the point R300 to the point R306, the point G301 to the point G307, and the point B302 to the point B308 respectively in a pseudo manner as indicated by the arrows in FIG. 10. However, since it does not mean that the color reproducibility of the display device 3 itself is expanded, an image on the display device 3 is displayed with its color being saturated within the triangle formed by the points R300, G301 and B302. Neutral colors, on the other hand, are displayed vividly, and therefore an appropriate setting of a color conversion parameter enables color saturation to be minimized and therefore the image to be displayed vividly.

Accordingly, it is necessary to make an appropriate selection of the color chromaticity points R306, G307 and B308 indicating the color reproducibility to be obtained and to display the image which has been actually processed by the color conversion processing circuit 51 on the display device 3 so as to make an adjustment to the target color reproducibility while checking the image quality. The image processing support system according to the present embodiment is well capable of supporting such requirement.

Processing to be actually performed by the color conversion processing circuit 51 in the present embodiment is a calculation presented as Expression (1). The following describes a parameter calculation method for carrying out a process corresponding to the aforementioned explanation given with reference to FIG. 10.

The input/output signals in Expression (1) are RGB signals, but since FIG. 10 shows an xy chromaticity chart, conversion to be conducted in this respect needs to be taken into consideration. A description is provided here for processing for mapping chromaticity points in the case where the input signals are displayed as they are on the color reproducibility range of the display device 3 over the chromaticity points on the target color reproducibility range. Letting the chromaticity of a certain color in the color reproducibility range of the display device 3 be x, y, and z, tristimulus values X, Y, and Z in the X Y Z system are,

X=xS, Y=yS, Z=zS (4).

Note, however, that S=X+Y+Z

Meanwhile, letting the chromaticity of the corresponding color in the target color reproducibility range be x′, y′ and z′, tristimulus values X′, Y′, and Z′ in the X Y Z system are,

X′=x′S′, Y′=y′S′, Z′=z′S′ (5).

Note, however, that S′=X′+Y′+Z′

The conversion from the XYZ tristimulus values to RGB tristimulus values is conducted using the following expression:

$$( \begin{matrix}R \\ G \\ B\end{matrix} ) = ( \begin{matrix}0.4184 & - 0.1586 & - 0.0828 \\ - 0.0912 & 0.2524 & 0.0157 \\ 0.0009 & - 0.0026 & 0.1786\end{matrix} ) ( \begin{matrix}X \\ Y \\ Z\end{matrix} ) \qquad ( 6 )$$

For example, assuming that the xy chromaticity of each of the RGB chromaticity points when the input signals are directly displayed on the color reproducibility range of the display device 3 are R(Rx, Ry, Rz), G(Gx, Gy, Gz) and B(Bx, By, Bz), the following expression (7) resulted from Expressions (1), (4), (5) and (6) is used to determine a color conversion parameter used to adjust them to the xy chromaticity of each of the RGB chromaticity points R′(Rx′, Ry′, Rz′), G′(Gx′, Gy′, Gz′) and B′(Bx′, By′, Bz′) in the target color reproducibility range:

$$( \begin{matrix}A11 & A12 & A13 \\ A21 & A22 & A23 \\ A31 & A32 & A33\end{matrix} ) = ( \begin{matrix}0.4184 & - 0.1586 & - 0.0828 \\ - 0.0912 & 0.2524 & 0.0157 \\ 0.0009 & - 0.0026 & 0.1786\end{matrix} ) ( \begin{matrix}{Rx}^{′} & {Gx}^{′} & {Bx}^{′} \\ {Ry}^{′} & {Gy}^{′} & {By}^{′} \\ {Rz}^{′} & {Gz}^{′} & {Bz}^{′}\end{matrix} ) {( ( \begin{matrix}0.4184 & - 0.1586 & - 0.0828 \\ - 0.0912 & 0.2524 & 0.0157 \\ 0.0009 & - 0.0026 & 0.1786\end{matrix} ) ( \begin{matrix}Rx & Gx & Bx \\ Ry & Gy & By \\ Rz & Gz & Bz\end{matrix} ) )}^{- 1} \qquad ( 7 )$$

Using the above Expression (7), the parameter calculating unit 14 determines a color conversion parameter (A11, A12, A13, A21, A22, A23, A31, A32 and A33) used to convert each of the chromaticity points of the display device 3 R(Rx, Ry, Rz), G(Gx, Gy, Gz) and B(Bx, By, Bz) into the chromaticity points R′(Rx′, Ry′, Rz′), G′(Gx′, Gy′, Gz′) and B′(Bx′, By′, Bz′) adjusted to the target color reproducibility range.

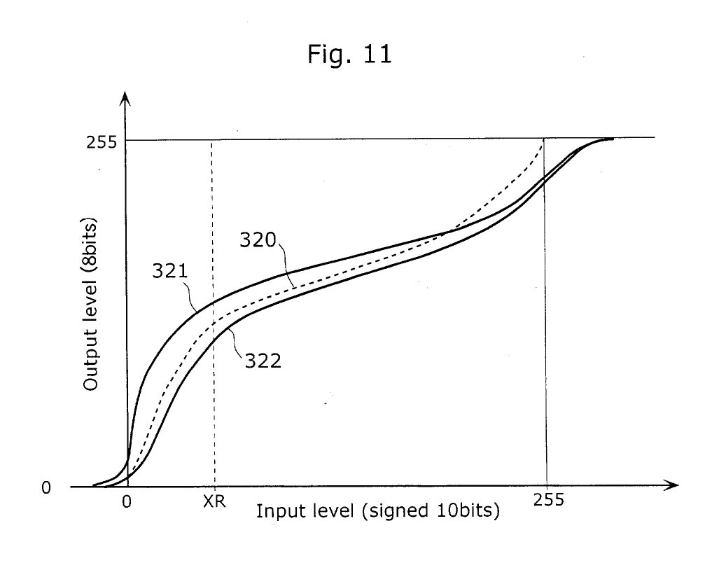

FIG. 11 is a diagram showing an example processing characteristic specified by the gamma correction parameter. This characteristic, which is based on the inverse characteristic of the gamma characteristic of the display device 3 illustrated in FIG. 3, is indicated by a curve 320 represented by a dashed line in FIG. 11. The curve 320 can be obtained by allocating “0” to the lowest brightness level and “255” to the highest brightness level on the Y axis shown in FIG. 3, and then exchanging the X axis with the Y axis.

Since a color enhancement process or a color control process is also performed in the color conversion processing circuit 51 in the present embodiment on the basis of the parameter adjusted to the curve 320, a necessary support is made on the part of the gamma correction circuit 52 and the gamma correction parameter. Output signals of the color conversion processing circuit 51 in the present embodiment are 10-bit parallel data, and therefore there is a possibility that a value exceeding 255 or a negative value is worked out as a result of matrix calculation.

Accordingly, as indicated by curves 321 and 322 shown by solid lines in FIG. 11, the following characteristics are to be realized: a characteristic in which an output corresponding to an input value exceeding 255 on the X axis has a gradual saturation characteristic so as to be controlled to 255 at maximum; and a characteristic in which an output corresponding to a negative input value on the X axis has a gradual saturation characteristic so as to be controlled to be 0 or over. In order to support these characteristics, the gamma correction circuit 52, in addition to the configuration of the inverse gamma correction circuit 50 shown in FIG. 6, is configured to input to the control unit 101 sign bits and bits added to higher bits, and add the initiation Y coordinate value and the termination Y coordinate value that add the number of broken lines in the direction of X axis.

Also, in order to improve visibility in dark scenes which are often included in a movie and others, it is also possible to make such a correction to the curve 320 as enables an output corresponding to a low input level to be slightly higher, just like the characteristic indicated by the curve 321 shown by the solid line, for example. However, in the case of compressed images such as those compliant with MPEG, for example, there occurs a case where an excessive brightening up of dark scenes results in an unsightly block noise in a part of a scene which is supposed to be all black. In order to circumvent this, it is also possible to make such a correction as can control brightness slightly to a lower level, just like the characteristic indicated by the curve 322 shown by the solid line, for example. These characteristics can be easily calculated using a method similar to Expression (3), for example.

The inverse gamma correction parameter, the color conversion parameter, and the gamma correction parameter calculated by the parameter calculating unit 14 of the image processing support device 1 are outputted to the image processing circuit 2 by the parameter setting unit 15.

In the signal processing parameter calculation operation described above, it is necessary to check image quality on a display device to be actually used, in order to obtain a visually satisfactory image through brightness and color control. An operator can compare the variations in the signal processing parameters and image quality to be actually displayed on the display device 3 by the parameter calculating unit 14 in FIG. 2 displaying, for such operator, parameter calculation information (e.g. measured values and target values used for signal processing parameter calculations as well as calculation results, values to be obtained in the middle of the calculations) used for determining signal processing parameters on the operation screen display device 5 via the image signal outputting unit 17 and further transferring the calculated signal processing parameters to the image processing circuit 2 so as to output to the display device 3 an actually processed image signal.

Moreover, a plurality of parameter information corresponding to each of a plurality of the signal processing parameters prepared using the above method are also prepared. An explanation is given here for the case where the amount of color expansion indicated by a color conversion parameter and the amount of partial brightness enhancement indicated by a gamma correction parameter are used as parameter information as described above. As the amount of color expansion, it is possible to use the average value of a distance between each of the chromaticity points R(Rx, Ry, Rz), G(Gx, Gy, Gz) and B(Bx, By, Bz) and the chromaticity points representing the target color reproducibility range R′(Rx′, Ry′, Rz′), G′(Gx′, Gy′, Gz′) and B′(Bx′, By′, Bz′) of the display device 3 illustrated in FIG. 10, for example. Meanwhile, as the amount of partial brightness enhancement, an output level value when an input level is XR in FIG. 11, for example, can be used. Or, values corresponding to A and B in Expression (3) may be used, as they are, as the amount of partial brightness enhancement. These values can be easily determined by the parameter calculating unit 14 illustrated in FIG. 2, and can be displayed onto the operation image display device 5 via the image signal outputting unit 17 so as to be shown to the operator for confirmation purposes.

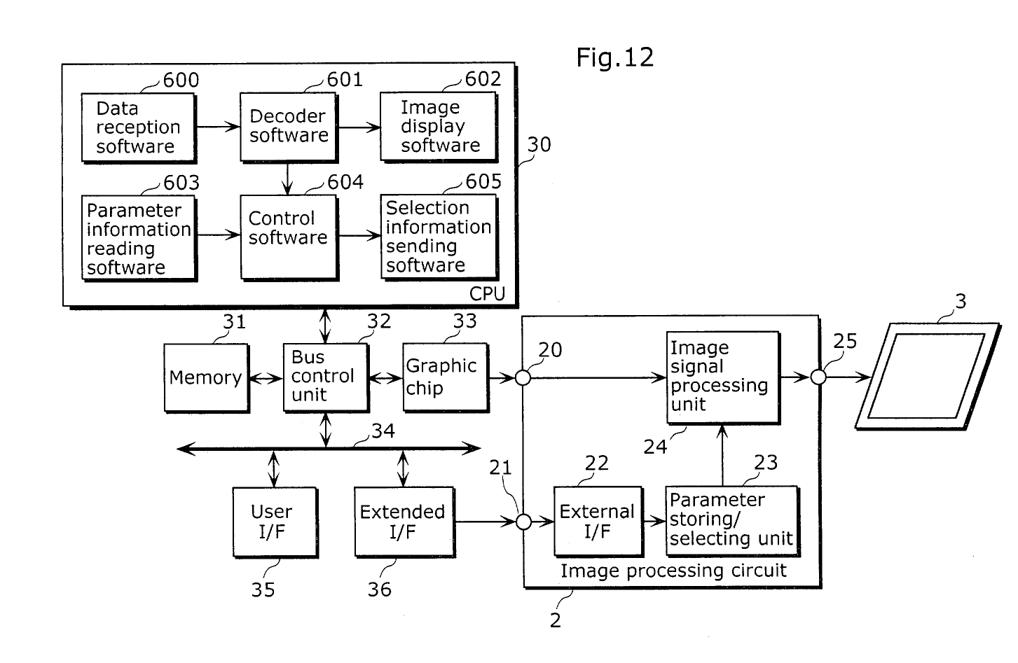

Next, an explanation is given for the case where the image processing device illustrated in FIG. 1 is embodied by using the signal processing parameters prepared in the above manner, utilizing the image processing support system shown in FIG. 2 and the image processing circuit 2. FIG. 12 is a block diagram showing the configuration of such image processing device. In FIG. 12, the same reference numbers are assigned to the same components as those shown in FIG. 2 and detailed explanations thereof are omitted.

The image processing device is comprised of the image processing circuit 2, a CPU 30, a memory 31, a bus control unit 32, a graphic chip 33, a bus 34, a user interface 35, and an extended interface 36. The output terminal 25 of the image processing circuit 2 is connected to the display device 3. On the CPU 30, the following software are executed: data reception software 600, decoder software 601, image display software 602, parameter information reading software 603, control software 604, and selection information sending software 605.

Note that FIG. 12 shows a configuration in which the image processing circuit 2 is realized as a combination of the external interface 22 with the image signal processing unit 24 (the signal processing unit 502) and the parameter storing/selecting unit 23 (the parameter selecting unit 505 and the parameter storing unit 506), as described in the explanation of FIG. 2, and in which the decoding unit 501 and the control unit 504 are realized in the form of software.

Also note that the hardware configuration shown in FIG. 12 is equivalent to that of a general personal computer other than that the image processing circuit 2 is included. To the extended interface 36, various drives (e.g. CD-ROM and DVD) and a network interface (not illustrated in the diagram) are to be connected. The data reception software 600 receives compressed image data sent from these drives and the network, and outputs it to the decoder software 601. Such software as the data reception software 600 is generally provided, as driver software for drives and network interfaces to be connected to the extended interface 36, by vendors selling such drives and network interfaces.

The decoder software 601 decodes the compressed image data inputted from the data reception software 600 into a decomposed original image signal so as to output it to the image display software 602, and at the same time, reads out compressed image information indicating the type of the original image signal and details of compression processing from such compressed image data, and outputs it to the control software 604. The image display software 602 controls the graphic chip 33 so as to make it provide the original image signal inputted from the decoder software 601 to the input terminal 20 of the image processing circuit 2.

Meanwhile, the parameter information reading software 603 makes an access to the parameter storing/selecting unit 23 in the image processing circuit 2 via the extended interface 36 and the external interface 22, and reads out parameter information indicating the characteristics of the respective signal processing parameters, and outputs the readout parameter information to the control software 604.

The control software 604 determines a signal processing parameter to be used in the image signal processing unit 24 from among a plurality of the signal processing parameters stored in the parameter storing/selecting unit 23, according to both the compressed image information inputted from the decoder software 601 and parameter information inputted from the parameter information reading software 603. Then, the control software 604 outputs, to the selection information sending software 605, parameter selection information used for reading out such determined signal processing parameter.

When selecting a signal processing parameter, the control software 604 may utilize a compression ratio used by the decoder software 601 decoding compressed image data. In such a case, the decoder software 601 outputs, as compressed image information, the image size, frame rate, dada rate after compression of an original image signal to the control software 604. The control software 604 determines the data rate of the original image signal on the basis of the image size and frame rate, and judges that a compression ratio of the compressed image data is higher as the difference is bigger between the data rates before and after compression. When a compression ratio of the compressed image data is high, it is expected that a decomposed original image signal includes much compression noise.

Accordingly, when judging that the compression ratio of the compressed image data is high, the control software 604 selects a signal processing parameter whose color conversion parameter indicates a small amount of color expansion and whose gamma correction parameter indicates a small amount of partial brightness enhancement (or partial brightness control). Here, it is also possible to select a signal processing parameter whose inverse gamma correction parameter enables the level of a high input level part to get lowered so as to make compression noise less noticeable. Note that the image size, frame rate, dada rate after compression of an original image signal are described in its header in a video stream in the case of MPEG 2, for example.

Furthermore, other than using a compression ratio of compressed image data when selecting a signal processing parameter, it is also possible to use information which is effective in estimating whether or not a decoded image includes much compression noise. For example, in the case of MPEG 1/2, since it is estimated that a decoded image includes a larger amount of compression noise when the data rate after compression is CBR (Constant Bit Rate) than in a case of VBR (Variable Bit Rate), a signal processing parameter enabling a smaller amount of color expansion or partial brightness enhancement is selected. Similarly, when no B picture is proven to be included as a result of checking the frame structure of a GOP (Group Of Picture), a signal processing parameter enabling a smaller amount of color expansion or partial brightness enhancement is selected than in a case where a B picture is included. Also, when a large step value has proven to be used in the quantization step, a signal processing parameter enabling a small amount of color expansion or partial brightness enhancement is selected than in a case where a small step value is used.

Regarding the decoder software 601, it is either possible to employ decoder software supporting a plurality of compression methods, or to employ more than one decoder software which are appropriately used depending on compressed image data to be inputted, but information indicating which compression method is used may also be utilized in selecting a signal processing parameter. For instance, since there tends to be a larger amount of compression noise in an image which has been compressed in such a method as MotionJPEG and DV (Digital Video) employing only intra-frame compression than in a case of an MPEG method, even when the same compression ratio is employed, a signal processing parameter enabling a smaller amount of color expansion or partial brightness enhancement is selected.

Furthermore, when decoding compressed image data reproduced from a DVD and displaying decoded image data, a regional code in the DVD may be used in the selection of a signal processing parameter. When compressed image data reproduced from a DVD is inputted, the decoder software 601 incorporates its regional code into compressed image information to be outputted to the control software 604. The control software 604 checks the regional code it receives, and makes an appropriate selection of a signal processing parameter by selecting one whose inverse gamma correction parameter enables a larger amount of brightness enhancement, when the received regional code indicates areas including Japan, while selecting one whose inverse gamma correction parameter enables a comparatively small amount of brightness enhancement, when the received regional code indicates areas including the United Sates.

Subsequently, the selection information sending software 604 outputs the parameter selection information prepared by the control software 604 in the above manner to the parameter storing/selecting unit 23 in the image processing circuit 2 via the extended interface 36 and the external interface 22. Based on the inputted parameter selection information, the parameter storing/selecting unit 23 outputs, to the image signal processing unit 24, the signal processing parameter selected by the control software 604 from among a plurality of the signal processing parameters. Then, using this signal processing parameter inputted by the parameter storing/selecting unit 23, the image signal processing unit 24 performs signal processing on the original image signal inputted from the graphic chip 33, and outputs the processed original image signal onto the display device 3 through the output terminal 25.

As explained above, the present embodiment allows the volume production of display apparatuses which incorporate, together with a display device, an image processing device capable of storing a plurality of signal processing parameters after setting a signal processing parameter which is best suited to perform brightness/color correction and enhancement for a display device by using not a DSP but a small-scale dedicated hardware, and selecting and applying an optimum signal processing parameter from among such plurality of signal processing parameters after comparing the characteristics of input compressed image data and a signal processing parameter.

Also, unlike the case where individual end users conduct color management of their own, the present embodiment allows apparatus manufacturers to supply in quantity image display apparatuses capable of providing visually superior images, utilizing their accumulated expertise about display devices.

(Second Embodiment)

In the color conversion processing circuit 51 explained in the first embodiment, it is unavoidable that color expansion processing results in enhanced compression noise when processing involving a large amount of color expansion is required to be performed also on compressed image data including much compressed noise, from the standpoint of color reproducibility of a display device and the contents of compressed image data. In response to this, the present embodiment describes the case where color expansion processing is performed after applying lowpass filter to an original image signal resulted from decomposing compressed image data, in order to reduce compression noise.

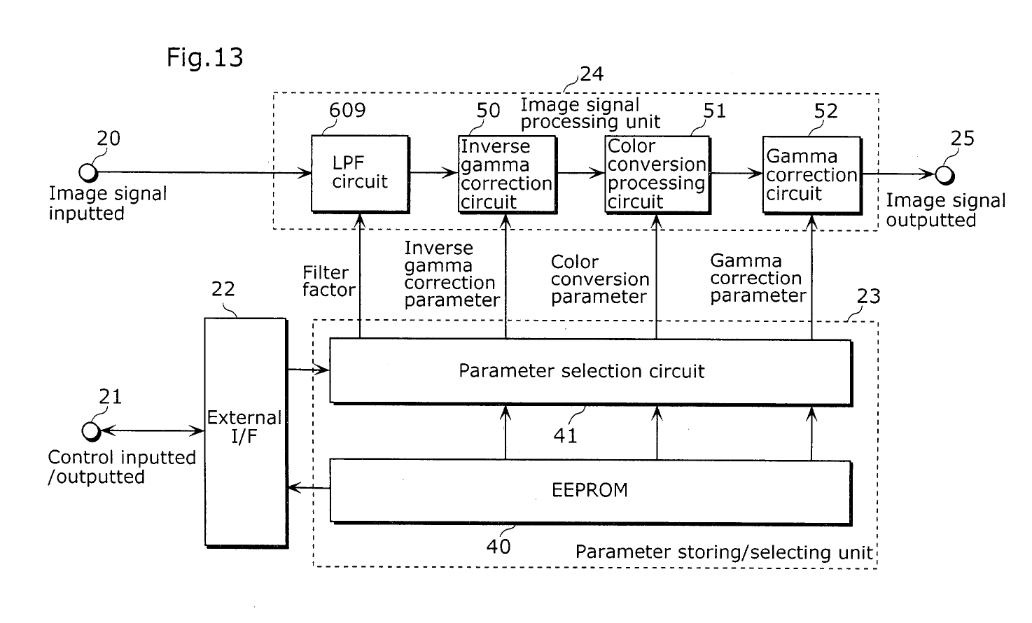

FIG. 13 is a block diagram showing the configuration of the image processing circuit 2 in an image processing device according to the second embodiment of the present invention. The configuration shown in FIG. 13 is a configuration to which lowpass filter processing to be performed on an image signal is added, compared with the configuration illustrated in FIG. 5. In FIG. 13, the same reference numbers are assigned to the same components as those shown in FIG. 5 and detailed explanations thereof are omitted.

The image signal processing unit 24 of the image processing circuit 2 includes a lowpass filter (to be referred to as “LPF” hereinafter) circuit 609 in addition to the components shown in FIG. 5. This LPF circuit 609, which is made up of digital filters such as a FIR (Finite Impulse Response) filter and an IIR (Infinite Impulse Response) filter, limits the band of an input image signal using a selected filter factor. In the EEPROM 40, a plurality of filter factors are stored.

When the image processing circuit 2 with the above configuration is employed in the image processing device illustrated in FIG. 12, the control software 604 outputs such parameter selection information as allows a filter factor to be set in the LPF circuit 609, the filter factor enabling the LPF circuit 609 to limit a band strongly (i.e. narrows a pass band) when a signal processing parameter whose color conversion parameter indicates a large amount of color expansion and whose gamma correction parameter indicates a large amount of partial brightness enhancement.

The first embodiment describes a control for reducing the amount of color expansion and partial brightness enhancement, when there is much compression noise, by the use of a compression ratio of compressed image data or information which is effective in estimating whether or not a decoded image includes much compression noise, but it is possible in the present embodiment to set such a filter factor as enables the LPF circuit 609 to narrow a pass band without reducing the amount of color expansion or partial brightness enhancement.

For example, the decoder software 601 outputs, as compressed image information, the image size, frame rate, dada rate after compression of an original image signal to the control software 604. Then, the control software 604 determines the data rate of the original image signal on the basis of the image size and frame rate, and judges that a compression ratio of the compressed image data is higher as the difference is bigger between the data rates before and after compression, and selects such a filter factor as enables the LPF circuit 609 to narrow a pass band.

As described above, since a filter factor used by the LPF circuit 609 is selected according to an input image signal in the present embodiment, an image with a satisfactory image quality can be always displayed because an excessive band limitation is not conducted to the band of an image signal which results in an image lacking detailed information, and a pass band is made narrower only in the case where compression noise is likely to be enhanced in the subsequent processing, when processing which does not much require LPF processing and which involves a small amount of color expansion, and when compressed image data including a small amount of compressed noise is decoded and displayed as a decoded image.

(Third Embodiment)

The first embodiment explains the case where a regional code of a DVD is used when selecting a signal processing parameter in the configuration illustrated in FIG. 12, but the fact is that it is difficult to separately control a user's liking of brightness and a noise level simply by controlling the amount of brightness enhancement indicated by an inverse gamma correction parameter. In order to solve this problem, the present embodiment describes the case where an adjustment can be made to brightness also by controlling the backlight of the display device 3.

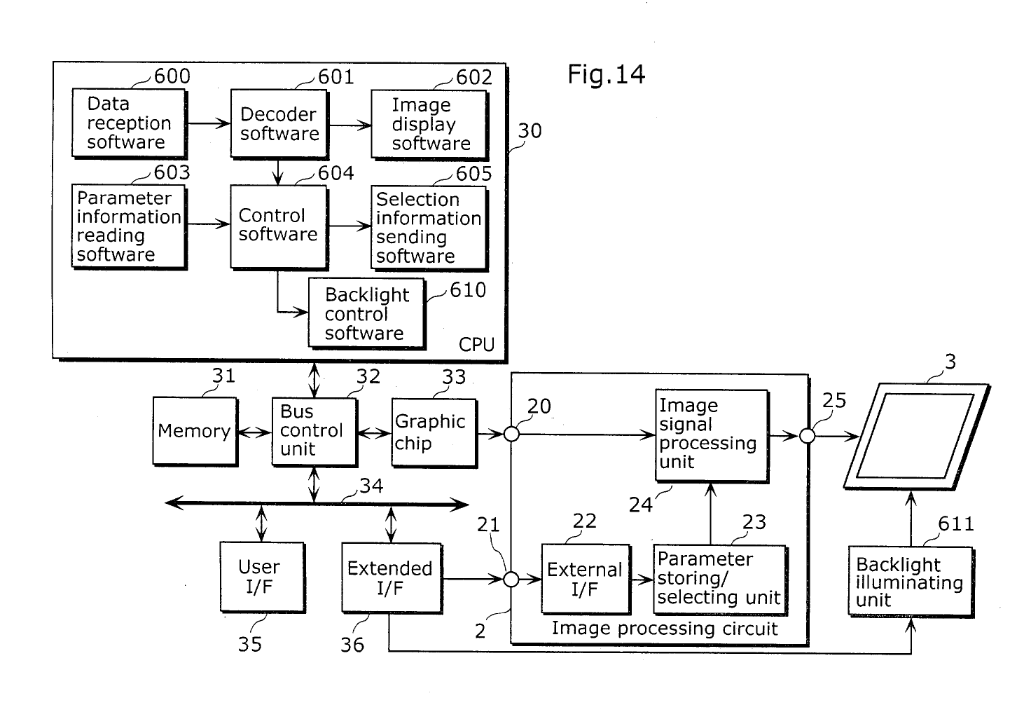

FIG. 14 is a block diagram showing the configuration of an image processing device according the third embodiment of the present invention. The configuration shown in FIG. 14 is a configuration to which backlight control to be conducted for the display device 3 is added, compared with the configuration illustrated in FIG. 12. In FIG. 14, the same reference numbers are assigned to the same components as those shown in FIG. 12 and detailed explanations thereof are omitted.

In the present embodiment, a backlight illuminating unit 611 for illuminating the backlight of the display device 3 is added to the configuration shown in FIG. 12, being connected to the extended interface unit 36. In this regard, the backlight control software 610 is executed on the CPU 30.

The control software 604 checks a regional code sent from the decoder software 601, and selects a signal processing parameter whose inverse gamma correction parameter enables a comparatively small amount of brightness enhancement when the received regional code indicates areas including the United Sates, while selecting a signal processing parameter whose inverse gamma correction parameter enables a slightly larger amount of brightness enhancement when the received regional code indicates areas including Japan. Then, the control software 604 outputs parameter selection information in accordance with each selection result. Note that the parameter storing/selecting unit 23 shall store such an inverse gamma correction parameter as suppresses the amount of brightness enhancement so that brightness will not be enhanced too much.

When the control software 604 outputs parameter selection information indicating that a signal processing parameter enabling a slightly large amount of brightness enhancement to be conducted, the backlight control software 610 outputs a backlight control signal that raises the level of backlight illumination to the backlight illuminating unit 611 via the extended interface unit 36. Based on the backlight control signal inputted by the backlight control software 610, the backlight illuminating unit 611 raises the level of backlight illumination, i.e., controls the screen of the display device 3 to become brighter.

As described above, the present embodiment is capable of preventing compression noise from becoming too noticeable also by controlling the brightness of the backlight of the display device 3 regarding brightness, and by increasing the amount of brightness enhancement through a gamma correction parameter.

Furthermore, when the backlight is not required to be made bright as in a case where a DVD including a regional code dedicated for a region in which bright screen is preferred, is not reproduced, it is possible with the present embodiment to prevent the amount of power consumption from becoming large by suppressing the brightness of the backlight when not necessary.

Note that although the parameter storing unit outputs parameter information to the control unit in the preferred embodiments of the present invention, it may also be possible that a signal processing parameter itself is simply outputted and the control unit obtains parameter information by analyzing such input signal processing parameter. In this case, it is possible to directly extract values of A11, A22 and A33 from a color conversion parameter in Expression (1), and utilize them as the amount of color expansion. Meanwhile, as the amount of brightness enhancement, an output level value corresponding to an input level XR illustrated in FIG. 11 can be easily determined from a gamma correction parameter. Of course, other values are utilized for each of the above cases.

Furthermore, although explanations are given for the case where input signals of the display device 3 are 8-bit parallel RGB digital signals, the present invention is not limited to such signals, and image signals in general are also in the scope of application. Also note that the display device 3 is not limited to the liquid crystal display of a notebook PC, and therefore that the same effect can be achieved by using a general display device such as a CRT and a PDP.

Moreover, although an explanation is given for the case where 3×3 matrix calculation is employed as a color conversion process, the present invention is not limited to this, and therefore another color conversion process is also in the scope of application.

As explained above, since a signal processing parameter to be used is selected according to input compressed image data, it is possible to perform signal processing best suited for the compressed image data and to vividly display such processed image data onto the display device. Furthermore, since not a DSP but a small-scale dedicated hardware is used, the image processing device of the present invention is suited to be incorporated into a portable display device in terms of power consumption and the scale of a device. Moreover, the image processing device according to the present invention is capable of allowing, even when more than one type of display devices are used, each of such display devices to be performed of optimal brightness/color correction and enhancement as well as allowing volume production of display apparatuses which incorporate such a display device and an image processing device as a set.

What is more, utilizing the characteristic of control processing which has been adjusted to best suit the characteristics of each display device, the image processing device according to the present invention is capable of preventing noise of an image, which has been compressed at a high compression ratio and which therefore tends to include much compression noise, from becoming noticeable, as well as capable of controlling the brightness and colors of an image which has been compressed at a low compression ratio, to make them sufficiently enhanced.

What is claimed is:

1. An image processing device for performing signal processing on an input image signal according to a signal processing parameter that associates the image signal with a display style of the image signal, the image processing device comprising:
a decoding unit operable to (i) decode input compressed image data into an original image signal and output the original image signal, and (ii) read out, from the compressed image data, compressed image information indicating a type of the original image signal and details of compression and output the readout compressed image information;
a parameter storing unit operable to store a plurality of signal processing parameters;
a control unit operable to determine one of the plurality of signal processing parameters on the basis of the compressed image information outputted by the decoding unit and the plurality of signal processing parameters read out from the parameter storing unit, and output parameter selection information for identifying the determined signal processing parameter;
a parameter selecting unit operable to read out and output said one of the plurality of signal processing parameters stored in the parameter storing unit according to the parameter selection information outputted by the control unit; and
a signal processing unit operable to perform signal processing on the original image signal outputted by the decoding unit according to the signal processing parameter outputted by the parameter selecting unit.

2. The image processing device according to claim 1,
wherein the control unit extracts, as parameter information, a characteristic of how the image signal and the display style are associated with each other on a per-signal processing parameter basis, from the plurality of signal processing parameters, and determines said one of the plurality of signal processing parameters according to the compressed image information and the parameter information.

3. An image processing device for performing signal processing on an input image signal according to a signal processing parameter that associates the image signal with a display style of the image signal, the image processing device comprising:
a decoding unit operable to (i) decode input compressed image data into an original image signal and output the original image signal, and (ii) read out, from the compressed image data, compressed image information indicating a type of the original image signal and details of compression and output the readout compressed image information;
a parameter storing unit operable to store a plurality of signal processing parameters and parameter information of each of the plurality of signal processing parameters indicating a characteristic of how the image signal and the display style are associated with each other;
a control unit operable to determine one of the plurality of signal processing parameters on the basis of the compressed image information outputted by the decoding unit and the parameter information outputted by the parameter storing unit, and output parameter selection information for identifying the determined signal processing parameter;
a parameter selecting unit operable to read out and output said one of the plurality of signal processing parameters stored in the parameter storing unit according to the parameter selection information outputted by the control unit; and
a signal processing unit operable to perform signal processing on the original image signal outputted by the decoding unit according to the signal processing parameter outputted by the parameter selecting unit.

4. The image processing device according to one of claims 1 and 3,
wherein the control unit determines one of the plurality of signal processing parameters reflecting a characteristic of a display device that is post-connected to the image processing device, and outputs the parameter selection information for identifying the determined signal processing parameter reflecting the characteristic of the display device.

5. The image processing device according to one of claims 2 and 3,
wherein the signal processing parameter is a color conversion parameter for performing color conversion processing on the image signal,
the parameter information is an amount of color expansion indicated by the color conversion parameter,
the control unit determines one color conversion parameter from among a plurality of color conversion parameters on the basis of the compressed image information and the amount of color expansion, and
the signal processing unit performs color conversion processing on the original image signal according to the determined color conversion parameter.

6. The image processing device according to one of claims 2 and 3,
wherein the signal processing parameter is a gamma correction parameter for performing gamma correction processing on the image signal,
the parameter information is an amount of partial brightness enhancement indicated by the gamma correction parameter,
the control unit determines one gamma correction parameter from among a plurality of gamma correction parameters on the basis of the compressed image information and the amount of partial brightness enhancement, and
the signal processing unit performs gamma correction processing on the original image signal according to the determined gamma correction parameter.

7. The image processing device according to one of claims 1 and 3,
wherein the signal processing unit performs at least one of color expansion processing and partial brightness enhancement processing,
the compressed image information includes an image size, a frame rate, and a data rate after compression of the original image signal, and
the control unit calculates a data rate of the original image signal from the image size and the frame rate, and determines one of the plurality of signal processing parameters on the basis of a difference between the resulting data rate and the data rate after compression.

8. The image processing device according to claim 7,
wherein the control unit determines, from among the plurality of signal processing parameters, a signal processing parameter that decreases an amount of color expansion or an amount of partial brightness enhancement with an increase in a difference between the resulting data rate and the data rate after compression.

9. The image processing device according to one of claims 1 and 3,
wherein the compressed image information includes regional information indicating a region where the compressed image data should be reproduced, and
the control unit determines one of the plurality of signal processing parameters according to the regional information.

10. The image processing device according to claim 9,
wherein the regional information is a regional code included in a reproduced signal of an optical disc.

11. The image processing device according to one of claims 1 and 3,
wherein the compressed image data is obtained from a reproduced signal of an optical disc.

12. The image processing device according to one of claims 1 and 3,
wherein the signal processing unit performs at least one of lowpass filter processing, color expansion processing and partial brightness enhancement processing, and
the control unit determines, from among the plurality of signal processing parameters, a signal processing parameter that also makes a pass band narrower in lowpass filter processing, when an increased amount of color expansion is performed.

13. The image processing device according to one of claims 1 and 3 further comprising a brightness control signal generating unit operable to output a brightness control signal for controlling brightness of a light source of a display device which is post-connected to the image processing device, according to the parameter selection information outputted by the control unit.

14. An image processing method for performing signal processing on an input image signal according to a signal processing parameter that associates the image signal with a display style of the image signal, the image processing method comprising:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and the plurality of signal processing parameters outputted by a parameter storing unit operable to store the plurality of signal processing parameters, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step, according to the signal processing parameter outputted in the parameter selecting step.

15. An image processing method for performing signal processing on an input image signal according to a signal processing parameter that associates the image signal with a display style of the image signal, the image processing method comprising:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and parameter information outputted by a parameter storing unit operable store the plurality of signal processing parameters and the parameter information of each of the plurality of signal processing parameters indicating a characteristic of how the image signal and the display style are associated with each other, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step, according to the signal processing parameter outputted in the parameter selecting step.

16. A program for performing signal processing on an input image signal according to a signal processing parameter that associates the image signal with a display style of the image signal, the program causing a computer to execute the following steps:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and the plurality of signal processing parameters outputted by a parameter storing unit operable to store the plurality of signal processing parameters, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step, according to the signal processing parameter outputted in the parameter selecting step.

17. A program for performing signal processing on an input image signal according to a signal processing parameter that associates the image signal with a display style of the image signal, the program causing a computer to execute the following steps:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and parameter information outputted by a parameter storing unit operable store the plurality of signal processing parameters and the parameter information of each of the plurality of signal processing parameters indicating a characteristic of how the image signal and the display style are associated with each other, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step, according to the signal processing parameter outputted in the parameter selecting step.

18. A program causing an operation storage processing circuit of an image processing device to execute the following steps, the operation storage processing circuit including a CPU and a memory and the image processing device comprising the operation storage processing circuit and an image processing circuit:
a decoding step for (i) decoding input compressed image data into an original image signal and outputting the original image signal, and (ii) reading out, from the compressed image data, compressed image information indicating a type of the original image signal and details of compression and outputting the readout compressed image information; and
a control step for determining one of a plurality of signal processing parameters on the basis of the compressed image information outputted in the decoding step and the plurality of signal processing parameters outputted by a parameter storing unit operable to store the plurality of signal processing parameters, each associating an image signal and a display style of the image signal, and outputting parameter selection information for identifying the determined signal processing parameter,
wherein the image processing circuit of the image processing device includes:
the parameter storing unit;
a parameter selecting unit operable to read out and output said one of the plurality of signal processing parameters stored in the parameter storing unit, according to the parameter selection information outputted in the control step; and
a signal processing unit operable to perform signal processing on the original image signal outputted in the decoding step using the signal processing parameter outputted by the parameter selecting unit.

19. A program causing an operation storage processing circuit of an image processing device to execute the following steps, the operation storage processing circuit including a CPU and a memory and the image processing device comprising the operation storage processing circuit and an image processing circuit:
a decoding step for (i) decoding input compressed image data into an original image signal and outputting the original image signal, and (ii) reading out, from the compressed image data, compressed image information indicating a type of the original image signal and details of compression and outputting the readout compressed image information; and
a control step for determining one of a plurality of signal processing parameters on the basis of the compressed image information outputted in the decoding step and the plurality of signal processing parameters outputted by a parameter storing unit operable to store the plurality of signal processing parameters, each associating an image signal and a display style of the image signal and parameter information of each of the plurality of signal processing parameters indicating a characteristic of how the image signal and the display style are associated with each other, and outputting parameter selection information for identifying the determined signal processing parameter,
wherein the image processing circuit of the image processing device includes:
the parameter storing unit;
a parameter selecting unit operable to read out and output said one of the plurality of signal processing parameters stored in the parameter storing unit according to parameter selection information outputted in the control step; and
a signal processing unit operable to perform signal processing on the original image signal outputted in the decoding step using the signal processing parameter outputted by the parameter selecting unit.

20. A recording medium that stores a program for performing signal processing on an input image signal according to a signal processing parameter that associates the image signal and a display style of the image signal, the program causing a computer to execute the following steps:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and the plurality of signal processing parameters outputted by a parameter storing unit operable store the plurality of signal processing parameters, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step using the signal processing parameter outputted in the parameter selecting step.

21. A recording medium that stores a program for performing signal processing on an input image signal according to a signal processing parameter that associates the image signal and a display style of the image signal, the program causing a computer to execute the following steps:
a decoding step for (i) decoding input compressed image data into an original image signal and outputting the original image signal, and (ii) reading out, from the compressed image data, compressed image information indicating a type of the original image signal and details of compression and outputting the readout compressed image information;
a control step for determining one of a plurality of signal processing parameters on the basis of the compressed image information outputted in the decoding step and parameter information outputted by a parameter storing unit operable store the plurality of signal processing parameters and the parameter information of each of the plurality of signal processing parameters indicating a characteristic of how the image signal and the display style are associated with each other, and outputting parameter selection information for identifying the determined signal processing parameter;
a parameter selecting step for reading out and outputting said one of the plurality of signal processing parameters stored in the parameter storing unit according to the parameter selection information outputted in the control step; and
a signal processing step for performing signal processing on the original image signal outputted in the decoding step using the signal processing parameter outputted in the parameter selecting step.

22. A recording medium that stores a program causing an operation storage processing circuit of an image processing device to execute the following steps, the operation storage processing circuit including a CPU and a memory and the image processing device comprising the operation storage processing circuit and an image processing circuit:
a decoding step for (i) decoding input compressed image data into an original image signal and outputting the original image signal, and (ii) reading out, from the compressed image data, compressed image information indicating a type of the original image signal and details of compression and outputting the readout compressed image information; and
a control step for determining one of a plurality of signal processing parameters on the basis of the compressed image information outputted in the decoding step and the plurality of signal processing parameters outputted by a parameter storing unit operable to store the plurality of signal processing parameters, each associating an image signal and a display style of the image signal, and outputting parameter selection information for identifying the determined signal processing parameter,
wherein the image processing circuit of the image processing device includes:
the parameter storing unit;
a parameter selecting unit operable to read out and output one of the plurality of signal processing parameters stored in the parameter storing unit according to parameter selection information outputted in the control step; and
a signal processing unit operable to perform signal processing on the original image signal outputted in the decoding step using the signal processing parameter outputted by the parameter selecting unit.

23. A recording medium that stores a program causing an operation storage processing circuit of an image processing device to execute the following steps, the operation storage processing circuit including a CPU and a memory and the image processing device comprising the operation storage processing circuit and an image processing circuit:
a decoding step for (i) decoding input compressed image data into an original image signal and outputting the original image signal, and (ii) reading out, from the compressed image data, compressed image information indicating a type of the original image signal and details of compression and outputting the readout compressed image information; and
a control step for determining one of a plurality of signal processing parameters on the basis of the compressed image information outputted in the decoding step and the plurality of signal processing parameters outputted by a parameter storing unit operable to store the plurality of signal processing parameters, each associating an image signal and a display style of the image signal and parameter information of each of the plurality of signal processing parameters indicating a characteristic of how the image signal and the display style are associated with each other, and outputting parameter selection information for identifying the determined signal processing parameter,
wherein the image processing circuit of the image processing device includes:
the parameter storing unit;
a parameter selecting unit operable to read out and output one of the plurality of signal processing parameters stored in the parameter storing unit according to parameter selection information outputted in the control step; and
a signal processing unit operable to perform signal processing on the original image signal outputted in the decoding step using the signal processing parameter outputted by the parameter selecting unit.
